(19) United States
(12) Patent Application Publication
(10) Pub. No.: US 2006/0095485 A1
(43) Pub. Date: May 4, 2006

(54) System and method for permuting a vector

(76) Inventor: George S. Moore, Veradale, WA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/978,065

(22) Filed: Oct. 30, 2004

(51) Int. Cl. G06F 15/00

(52) U.S. Cl. 708/200

(57) ABSTRACT

In one embodiment, a method of permuting a vector comprises providing vector entries of the vector to an input stage of a permuting structure, wherein the permuting structure comprises a plurality of stages and interconnections for groups of vector entries between the plurality of plurality of stages such that any input vector entry can be routed to any output vector entry, loading control elements of the permuting structure with random control bits that control routing of vector entries between stages of the permuting structure, and routing the vector entries from an input stage of the permuting structure to an output structure according to the control bits using the permuting structure.

### TECHNICAL FIELD

The present application is generally related to systems and methods for permuting a vector.

### BACKGROUND OF THE INVENTION

In a number of applications, it is desirable to process an input vector to permute the vector elements in a random manner to generate an output vector. Also, it is desirable to perform the permutation at very high speeds. An optimal method to perform the permutation is factorial permutation. Factorial permutation uses a source of independent, uniformly distributed discrete random variables of arbitrary span or modulus, i.e. uniform over 0 to N−1 where N is an arbitrary integer. Also, it is assumed that the vector to be permuted is of length M. In factorial permutation, the first input element of the input vector is assigned to one of the M positions of the output vector using a random variable of span M−1. The second element is then assigned to one of the M−1 remaining positions using a random variable of span M−2. The assignment continues in a similar manner until the final element of the input vector is assigned to a position in the output vector. Randomization of the vector entries in this manner enables M! permutations.

Factorial permutation has limitations when applied to high speed applications. In particular, factorial permutation is a sequential algorithm. Although pipelining may be applied to adapt factorial permutation for high speed applications, such adaptation imposes significant complexity and latency in the integrated circuitry. The second and more difficult problem is obtaining uniform random numbers of arbitrary modulus. Some existing algorithms that enable such uniform random numbers to be generated are not generally amenable to high-speed operation. Another existing algorithm involves repeated trials to obtain a value in the allowable range and, hence, is not deterministic in time.

### SUMMARY

Some representative embodiments are directed to systems and methods that permute an input vector using a “butterfly” structure. The butterfly structure is similar to the butterfly structure used by the fast Fourier transform (FFT) and the fast Hadamard transform (FHT) algorithms. In one embodiment, the vector to be permuted comprises M vector entries and the corresponding butterfly structure comprises log₂M stages. The individual butterfly elements of the structure enable two respective vector entries to switch positions as the entries are routed between butterfly stages. Specifically, in each stage (denoted by “s”), the vector entries are grouped in groups of 2^{s} entries. In each stage, the arrangement of the butterfly elements enables the i^{th} vector element to switch positions with the 2^{s}-i^{th} vector element.

Some representative embodiments differ from the butterfly structures used by the FFT and FHT algorithms by implementing the butterfly elements to controllably route the vector entries. In particular, the routing of entries according to FFT and FHT algorithms occurs in a deterministic manner that is defined by the mathematics of the underlying transform. In contrast, some representative embodiments provide a control structure for each butterfly element. Depending upon the state of the control structure, two corresponding vector elements of a group will switch positions or will continue to the next stage without changing positions. The permutation of the input vector occurs by loading the states of the control structures using a randomization algorithm. By implementing the butterfly elements in this manner, any individual vector element can be routed to any position in the output vector depending upon the randomization of the control structures.

By implementing a vector permuter in this manner, some representative embodiments may provide a relatively large amount of randomness. Specifically, the butterfly structure can yield 2ˆ{(M/2)(log₂M)} permutations. Additionally, the butterfly elements can be implemented using 2-to-1 multiplexors as an example. Accordingly, the butterfly structure can be readily pipelined and operated at very high speeds. Also, if the vector to be randomized has a number of vector entries that is a power of two, the generation of bits for the control structures may occur using algorithms that are well-suited for high speed operation.

### BRIEF DESCRIPTION OF THE DRAWINGS

FIG. 1 depicts a butterfly structure for permuting a vector according to one representative embodiment.

FIG. 2 depicts an implementation of a butterfly element according to one representative embodiment.

FIGS. 3A and 3B depict a barrel shifter that may be used to permute a vector and a corresponding truth table according to one representative embodiment.

### DETAILED DESCRIPTION

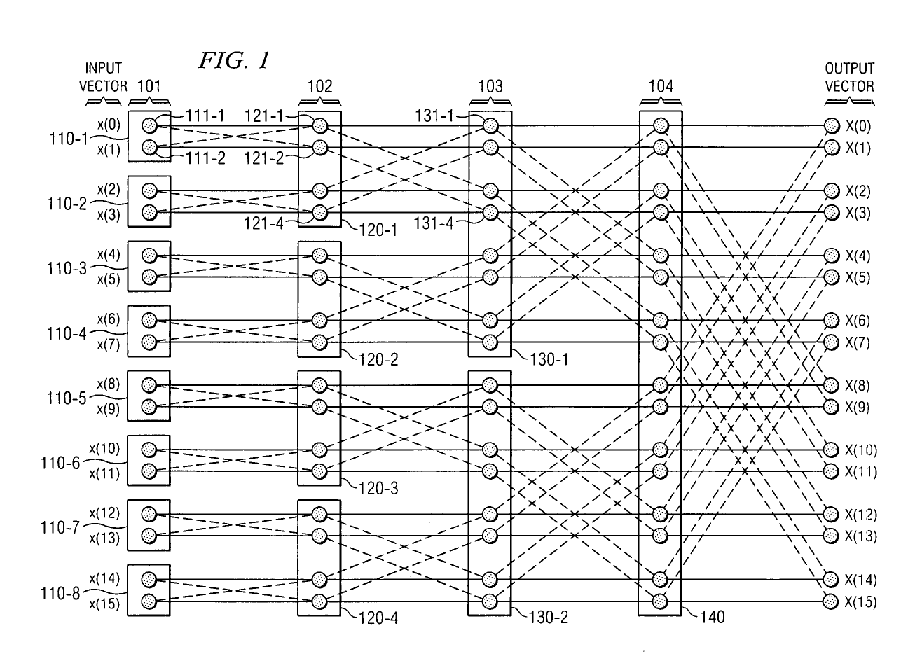

Referring now to the drawings, FIG. 1 depicts butterfly structure 100 according to one representative embodiment. Butterfly structure 100 only illustrates the potential routing of vector elements between stages. As shown in FIG. 1, butterfly structure 100 omits the illustration of the hardware elements used to perform the routing and the connections between the hardware elements for the sake of clarity.

The vector to be permuted comprises sixteen vector entries (denoted by x(0)-x(15)). The entries to be permuted can be single bit values or digital words. The number of stages in butterfly structure 100 is four. In the general case, to enable any input vector entry to be routed to any output vector entry, Log₂M stages are employed where M represents the total number of vector entries. In each stage of butterfly structure 100, eight (M/2) butterfly elements (not shown) are used to switch corresponding vector elements. Accordingly, the total number of butterfly elements and the total number of control bits equal 32 ((M Log₂M)/2)).

For the general case, the vector entries are grouped in groups of 2^{s} entries. In stage 101, there are eights groups (110-1 through 110-8) of two vector entries. In stage 102, there are four groups (120-1 through 120-4) of four vector entries. In stage 103, there are two groups (130-1 and 130-2) of eight entries and, in stage 104, there is only one group 140 of sixteen entries. Depending upon the state of the control structure of a butterfly element, corresponding vector elements will switch positions or will continue to the next stage at the same positions. Specifically, the i^{th} vector entry of a respective group will exchange positions with the 2^{s}-i^{th} vector entry or these two vector entries will maintain their positions.

In reference to stage 101, the vector entries are grouped in respective groups (110-1 through 110-8) of two entries each. For group 110-1, vector entries 111-1 and 111-2 can change positions depending upon the state of the control structure. For example, if the control structure of the corresponding butterfly element is set to “zero,” vector entry 111-1 would be routed to entry 121-1 of stage 102 and entry 111-2 would be routed to entry 121-2. Alternatively, if the control structure is set to “one,” entry 111-1 would be routed to entry 121-2 and entry 111-2 would be routed to entry 121-1. The other entries of the various groups are routed in a similar manner.

In reference to stage 102, the vector entries are grouped in respective groups (120-1 through 120-4) of four entries each. For group 120-1, vector entries 121-1 and 121-4 can change positions depending upon the state of the control structure. If the control structure of the corresponding butterfly element is set to “zero,” vector entry 121-1 would be routed to element 131-1 of stage 102 and entry 121-4 would be routed to entries 131-4. Alternatively, if the control structure is set to “one,” entry 121-1 would be routed to entry 131-4 and entry 121-4 would be routed to entry 131-1. The other entries of the various groups are routed in a similar manner.

The routing of entries continues in a similar manner to stage 104 and then to the output of the butterfly structure (denoted by output vector entries X(0)-X(15)). From the paths shown in FIG. 1, any input vector entry could be routed to any output vector entry. Although the number of possible permutations (2ˆ{(M/2)(log₂M)}) using butterfly structure 100 is less than the optimal number (M!), the number of permutations provides a sufficient degree of randomness for most applications. Butterfly structure 100 introduces dependencies between the routing of vector entries. For example, if entry 111-1 is routed to entry 121-1, entry 111-1 will only be routed to an even entry in the output vector and entry 111-2 will only be routed to an odd entry in the output vector. If a completely random permutation is performed, such dependency would not be present. If such dependency is not appropriate for a given application, one or several butterfly structures 100 could be cascaded to substantially mitigate the dependencies between the routing of vector entries.

Variations upon butterfly structure 100 may be performed according to other representative embodiments. For example, the arrangement of butterfly structure 100 could be inverted to form a mirror image of the interconnections in a manner similar to the “decimation-in-frequency” implementation of the FFT. Also, although the discussion of butterfly structure 100 has described the implementation of the routing when the number of vector entries in the input vector are a power of two, other embodiments may permute vectors of other sizes. Specifically, the butterfly structure may be extended to an M composite number in the same manner as the FFT structure has been extended to composite numbers.

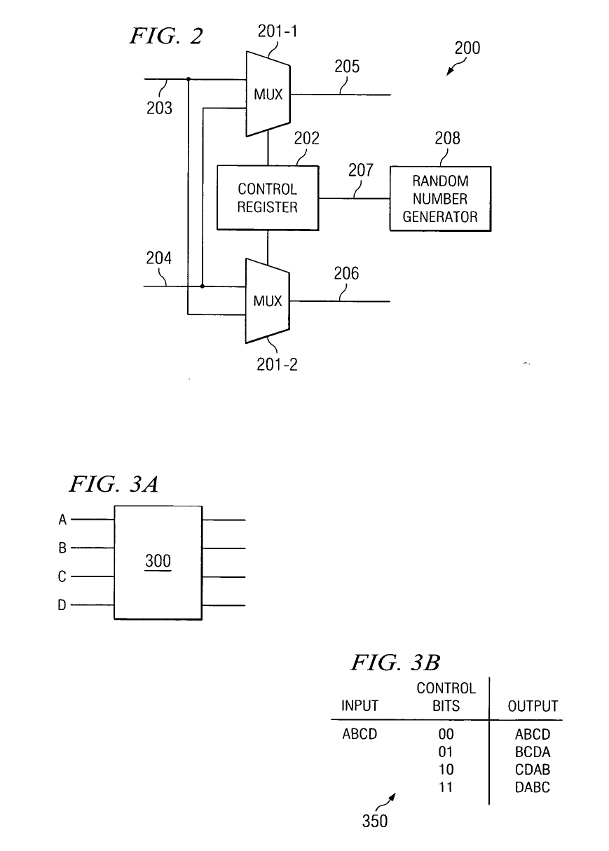

FIG. 2 depicts a discrete butterfly element for routing vector entries in a butterfly structure according to one representative embodiment. The routing of the vector entries is performed by 2-to-1 multiplexers 201-1 and 201-2. Multiplexers 201-1 and 201-2 are controlled by register logic 202. Specifically, a control bit can be loaded into register logic 202 by random number generator 208 via line 207. Register logic 202 then outputs the binary value to multiplexers 201-1 and 201-2. If the value of register logic 202 is “zero,” the value appearing on line 203 is routed to output line 205 and the value appearing on line 204 is routed to output line 206. Alternatively, if the register value of logic 202 is “one,” the value appearing on line 203 is routed to output line 206 and the value appearing on line 204 is routed to output line 205.

Although the description of butterfly structure 100 relies on routing only two corresponding vector entries in a dependent manner at each routing location, other routing mechanisms may be employed. Instead of butterfly element 200 shown in FIG. 2, barrel shifters may be employed to route vector entries between stages. A barrel shifter is a hardware element that can shift or rotate a data word by a defined number of bits. For example, 4-input, 4-output barrel shifters could be employed using a radix-4 decomposition or 8-input, 8-output barrel shifters could be employed depending upon the number of vector entries to be permuted. FIG. 3A depicts a block diagram of 4-input, 4-output butterfly element 300 and FIG. 3B depicts a truth-table description 350 of butterfly element 300. Butterfly element 300 operates according to two control bits. As seen in FIG. 3B, the number of bits of rotation applied to the four-bit data word (ABCD) is defined by the control bits (i.e., 00—zero rotation, 01—1 bit of rotation, 10—2 bits of rotation, and 11—3 bits of rotation). The use of higher order barrel shifters reduces the number of control bits in an application. For example, permutation of a 64 bit vector using an arrangement similar to butterfly structure 100 would involve 192 bits while the permutation of the vector using 8-bit barrel shifters (with three control bits) would involve 48 control bits.

By implementing a vector permuter using suitable permuting structures, some representative embodiments may provide a relatively large amount of randomness with a relatively low degree of circuit complexity. In some embodiments, a butterfly structure can yield 2ˆ{(M/2)(log₂M)} permutations. Additionally, the butterfly elements can be implemented using 2-to-1 multiplexors or other low complexity logic devices as examples. Accordingly, butterfly structures can be readily pipelined and operated at very high speeds. Also, if the vector to be randomized has a number of vector entries that is a power of two, the generation of bits for the control structures may occur using algorithms that are well-suited for high speed operation.

What is claimed is:

1. A method of permuting a vector, comprising:
providing vector entries of said vector to an input stage of a permuting structure, wherein said permuting structure comprises a plurality of stages and interconnections for groups of vector entries between said plurality of plurality of stages such that any input vector entry can be routed to any output vector entry;
loading control elements of said permuting structure with random control bits that control routing of vector entries between stages of said permuting structure; and
routing said vector entries from an input stage of said permuting structure to an output structure according to said control bits using said permuting structure.

2. The method of claim 1 wherein said permuting structure comprises butterfly elements that switch two corresponding vector entries between two stages of said permuting structure or cause said corresponding vector entries to continue between said two stages at the same positions depending upon a respective control bit.

3. The method of claim 2 wherein each butterfly element comprises two 2-to-1 multiplexers coupled to a control register.

4. The method of claim 1 wherein each stage of said permuting structure groups vector entries in groups of 2^{S} entries, wherein S denotes the stage of the permuting structure.

5. The method of claim 3 wherein said interconnections of said permuting structure enables an i^{th} vector entry of a group to be switched with an (2^{S}-i^{th}) vector entry of the group.

6. The method of claim 1 wherein a number of said vector entries is a power of two.

7. The method of claim 5 wherein said permuting structure comprises log₂M stages, wherein M represents a number of vector entries of said vector.

8. The method of claim 1 further comprising:
routing said vector entries from an input stage of a successive permuting structure to an output stage of said successive permuting structure according to control bits, wherein said successive permuting structure is cascaded with said permuting structure.

9. The method of claim 1 wherein said permuting structure comprises:
barrel shifters to route vector entries between said plurality of stages.

10. The method of claim 1 further comprising:
generating said control bits in a pseudo-random manner.

11. The method of claim 1 wherein said vector entries are single bit entries.

12. The method of claim 1 wherein said vector entries are digital words.

13. A system for permuting a vector, comprising:
a plurality of stages including an input stage for receiving entries of said vector and an output stage for outputting a permuted version of said vector, wherein each stage of said plurality of stages comprises logic elements for controllably switching positions of a subset of entries of said vector;
interconnections between said logic elements of said plurality of stages; and
a control element for loading bits into said logic elements of said plurality of stages in a pseudo-random manner to control operation of said logic elements;
wherein said logic elements and said interconnections are arranged such that any entry of said vector can be routed to any output position of said output stage.

14. The system of claim 13 wherein each of said logic elements comprises two multiplexers for receiving two entries from a prior stage, wherein said multiplexers are configured to switch positions of said two entries in response to a first value of a control bit and are configure to maintain positions of said two entries in response to a second value of said control bit.

15. The system of claim 14 wherein said each of said logic elements comprises a register for storing said control bit.

16. The system of claim 14 each stage of said plurality of stages groups entries in groups of 2^{S} entries, wherein S denotes the respective stage of said plurality of stages.

17. The system of claim 16 wherein said interconnections are arranged to enable an i^{th} entry of a group to be switched with an (2^{S}-i^{th}) entry of the group.

18. The system of claim 16 wherein a number of said entries is a power of two.

19. The system of claim 18 said plurality of stages comprises log₂M stages, wherein M represents a number of entries of said vector.

20. The system of claim 15 wherein said logic elements are barrel shifters.

21. The system of claim 15 wherein said entries are single bit entries.

22. The system of claim 15 wherein said entries are digital words.
